(19) United States
(12) Patent Application Publication
(10) Pub. No.: US 2014/0215347 A1
(43) Pub. Date: Jul. 31, 2014

(54) PORTABLE DEVICE AND CONTROL METHOD THEREOF

(71) Applicant: HON HAI PRECISION INDUSTRY CO., LTD., New Taipei (TW)

(72) Inventor: WEI-TE LIN, New Taipei (TW)

(73) Assignee: HON HAI PRECISION INDUSTRY CO., LTD., New Taipei (TW)

(21) Appl. No.: 14/073,904

(22) Filed: Nov. 7, 2013

(30) Foreign Application Priority Data
Jan. 28, 2013 (TW) 102103224

(51) Int. Cl. G06F 3/0484

(52) U.S. Cl. CPC G06F 3/0484
USPC 715/740

(57) ABSTRACT

A portable device communicates with an electronic device. The portable device includes an interface module, a control module, and a display module. The interface module presets a plurality of interfaces corresponding to different applications. The control module executes an application corresponding to the input instruction and invokes the interface corresponding to the executed application. The control module further transmits the input operation instruction and parts of the invoked interface to the electronic device which executes the input operation instruction and displays the parts of the invoked interface, the first display module displays other parts of the invoked interface corresponding to the executed application.

### BACKGROUND

1. Technical Field

The present disclosure relates to a portable device and a control method.

2. Description of Related Art

Portable devices, such as tablet devices or mobile phones, include a screen to display video. The screen may be divided into a major region and an auxiliary region. The major region is used for displaying the video, and the auxiliary region is used for inputting comments related to the video display on the major region, or input commands to operate the video displayed on the major region. However, the auxiliary region may affect the size of the major region.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a schematic diagram of a portable device communicating with an electronic device in accordance with an embodiment.

FIG. 2 is a block diagram of the portable device of FIG. 1 in accordance with an embodiment.

FIG. 3 is a schematic diagram of a user interface of the portable device of FIG. 1 in accordance with an embodiment.

FIG. 4 is a schematic diagram of the portable device and the electronic device of the FIG. 1 in a first state in accordance with a first embodiment.

FIG. 5 is a schematic diagram of the portable device and the electronic device of the FIG. 4 in a second state in accordance with the first embodiment.

FIG. 6 is a schematic diagram of the portable device and the electronic device of the FIG. 1 in a first state in accordance with a second embodiment.

FIG. 7 is a schematic diagram of the portable device and the electronic device of the FIG. 6 in a second state in accordance with the second embodiment.

FIG. 8 is a flowchart of a control method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

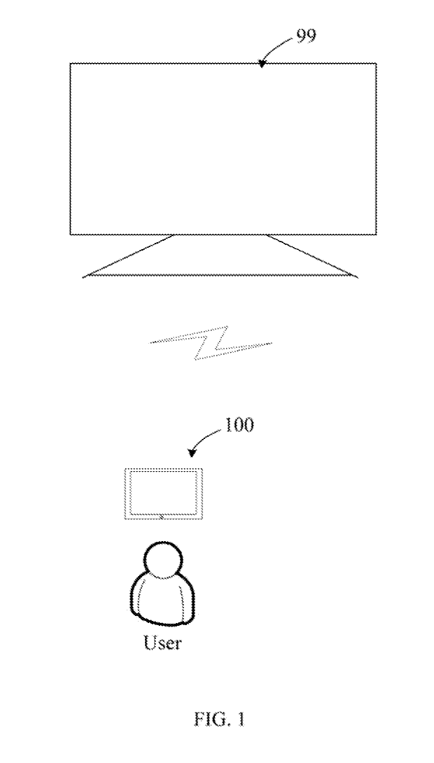

FIG. 1 shows a portable device 100 of an embodiment of the present disclosure. The portable device 100 communicates with an electronic device 99 and stores a plurality of files. The portable device 100 is capable of executing different applications and switching between a first state and a second state. The portable device 100 displays an interface of the executed application in the first state; and controls the electronic device 99 to execute the corresponding application and display a part of the interface of the executed application in the second state. In the embodiment, the portable device 100 is a tablet, and the electronic device 99 is a television; the portable device 100 connects with the electronic device 99 wirelessly. In other embodiments, the portable device 100 connects with the electronic device 99 via wires.

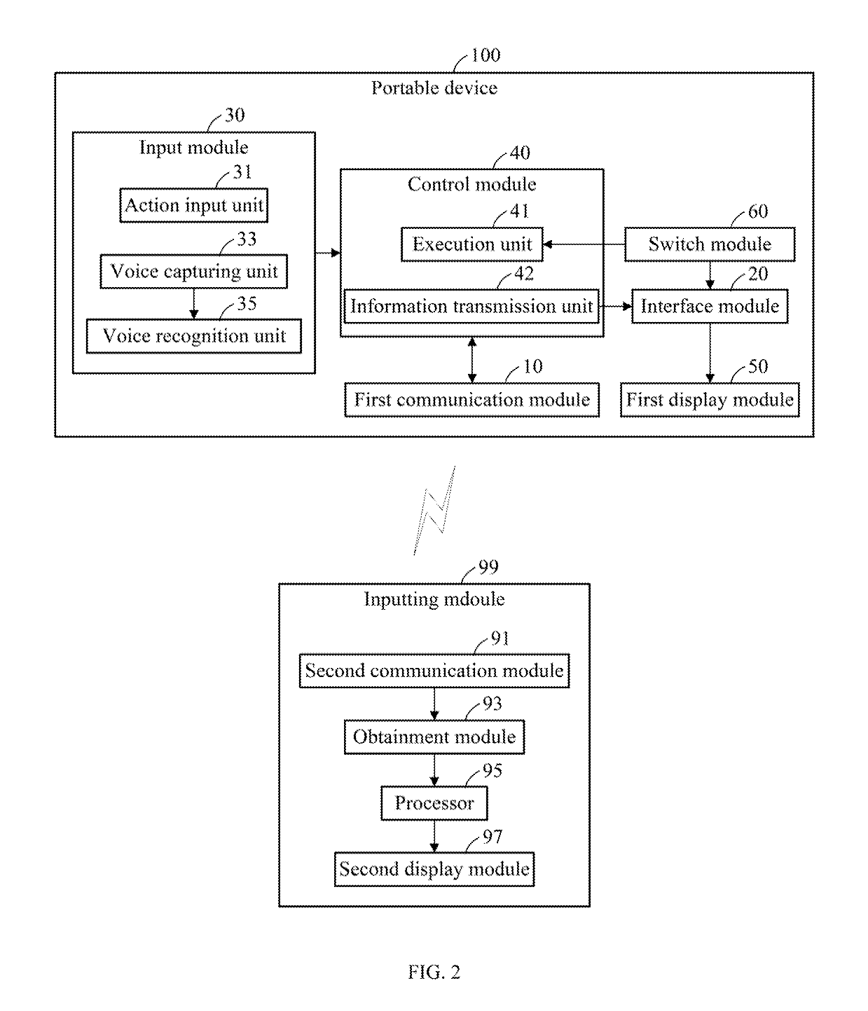

FIG. 2 shows that the portable device 100 includes a first communication module 10, an interface module 20, an input module 30, a control module 40, a first display module 50, and a switch module 60.

The first communication module 10 establishes a communication with the electronic device 99. In the embodiment, the first communication module 10 establishes the communication with the electronic device 99 based on an operation of users.

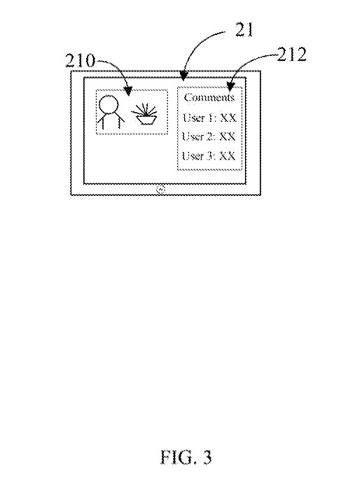

The interface module 20 presets a plurality of interfaces 21 corresponding to different applications. Each of the interfaces 21 defines a major region 210 and an auxiliary region 212. For example, one of the preset interfaces 21 (as shown in FIG. 3) corresponding to movie display application includes the major region 210 displaying a movie and the auxiliary region 212 displaying control icons. In the embodiment, the major region 210 can display images, video, or text information, for example; the auxiliary region 212 can display comments, a visual remote controller with a plurality of visual control icons, for example, for operating the content displayed on the major region 210.

The input module 30 generates different operation instructions based on operations of users. The input module 30 is capable of switching between a touch input mode and a voice input mode. The input module 30 includes a touch input unit 31, a voice capturing unit 33, and a voice recognition unit 35.

The touch input unit 31 generates different operation instructions base on the operations of the user when the input module 30 is in the touch input mode. In the embodiment, the operations can be a signal click operation, a double click operation, or a drafting operation.

The voice capturing unit 33 obtains voice information when the input module 30 is in the voice input mode.

The voice recognition unit 35 presets a plurality of voice information corresponding to different operation instructions. The voice recognition unit 35 determines whether the obtained voice information matches one of the voice information, and generates a corresponding operation instruction when the obtained voice information matches one of the voice information.

The control module 40 executes a corresponding application corresponding to the input operation instruction and invokes the interface 21 corresponding to the executed application. The control module 40 further transmits the invoked interface 21 to the first display module 50 when the portable device 100 is in the first state, and transmits the input operation instruction and the major region 210 to the electronic device 99 when the portable device 100 is in the second state. The control module 40 includes an execution unit 41 and an information transmission unit 42.

The execution unit 41 executes a corresponding application corresponding to the operation instruction and invokes the interface 21 corresponding to the executed application from the interface module 20. In the embodiment, the executed application can be a movie display application, a game application, and a chatting application, for example.

The information transmission unit 42 transmits the invoked interface 21 to the first display module 50 when the portable device 100 is in the first state. The information transmission unit 42 transmits the input operation instruction and the major region 210 of the interface 21 to the electronic device 99 via the first communication module 10 when the portable device 100 is in the second state.

The first display module 50 displays the interface 21 in a full-screen mode corresponding to the executed application simultaneously when the portable device 100 in the first state, and only displays the auxiliary region 212 of the interface 21 in a full-screen mode when the portable device 100 is in the second state. In the embodiment, the first display module 50 is a resistive or a capacitive touch screen.

The switch module 60 switches the portable device 100 between the first state and the second state based on operations of users. The switch module 60 also switches the input module 20 between the touch input mode and the voice input mode. In the embodiment, the operations are a click operation on different visual icons displayed on the first display module 50 or different pressed mechanism buttons of the portable device 100.

The electronic device 99 includes a second communication module 91, an obtainment module 93, and a second display module 95.

The second communication module 91 communicates with the first communication module 10.

The obtainment module 93 invokes the input operation instruction and the major region 210 from the second communication module 91. The obtainment module 93 further executes the input operation instruction and transmits the invoked major region 210 to the second display module 95.

The second display module 95 displays the invoked major region 210 in the full-screen mode.

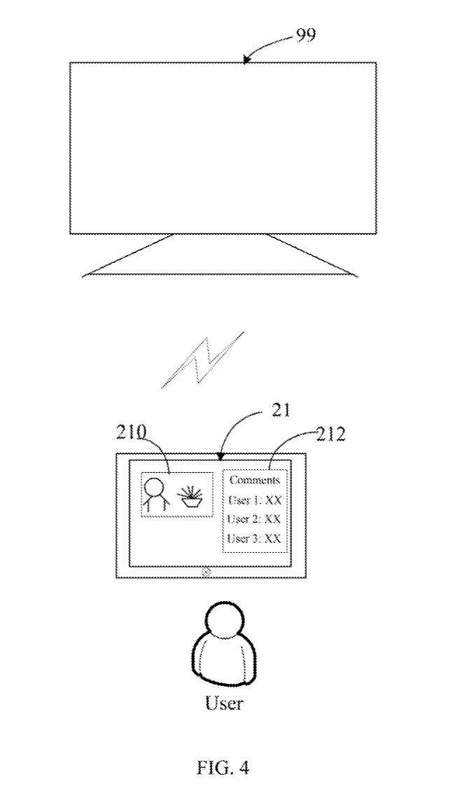

FIG. 4 shows the portable device 100 and the electronic device 99 in the first state of a first embodiment, when the input module 20 generates a movie display operation instruction based on a double click operation on one of the movies stored in the portable device 100, the execution unit 41 executes the movie display application to display the selected movie and invokes the interface 21 corresponding to the movie display application. The information transmission unit 42 transmits the invoked interface 21 to the first display module 50. The first display module 50 simultaneously displays the major region 210 for displaying the selected movie and the auxiliary region 212 for displaying the comments related to the displayed movie. In the embodiment, the auxiliary region 212 is also used for editing and uploading a comment to the internet.

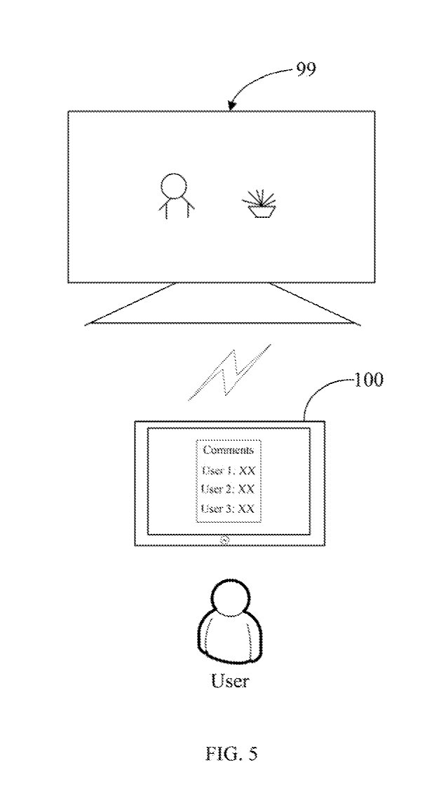

FIG. 5 shows the portable device 100 and the electronic device 99 in the second state of a first embodiment, when the portable device 100 switches into the second state, the information transmission unit 42 transmits the display operation instruction and the major region 210 of the interface 21 to the electronic device 99. Thus, the first display module 50 displays the auxiliary region 212 in a full-screen mode, and the second display module 95 executes the movie display application and displays the major region 210 in the full-screen mode.

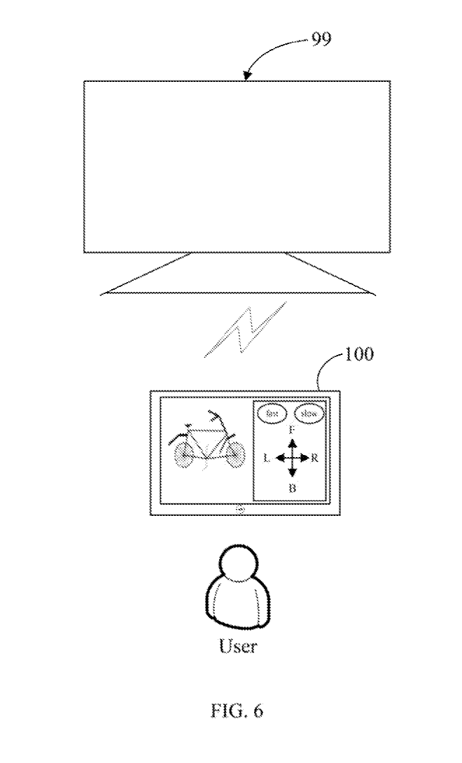

FIG. 6 shows the portable device 100 and the electronic device 99 in the first state of a second embodiment, when the touch unit 31 generates a game operation instruction based on a double click operation on one of the games stored in the portable device 100, the execution unit 41 executes the selected game application and invokes the interface 21 corresponding to the selected game application. The information transmission unit 42 transmits the invoked interface 21 to the first display module 50. The first display module 50 simultaneously displays the major region 210 for displaying images of the selected game and the auxiliary region 212 for displaying the visual controller related to the executed game. In the embodiment, the operations are also used for controlling the executed game in second display module 95 of the electronic device 99.

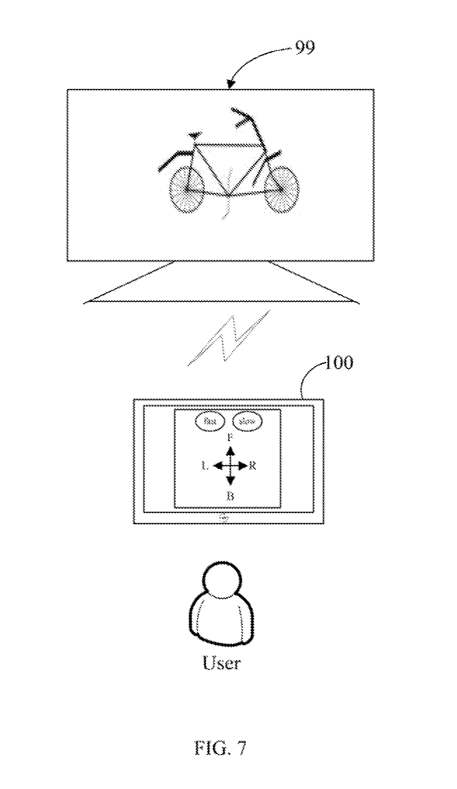

FIG. 7 shows the portable device 100 and the electronic device 99 in the second state of the second embodiment, when portable device 100 switches into the second state, the information transmission unit 42 transmits the game operation instruction and the major region 210 of the interface 21 to the electronic device 99. Thus, the first display module 50 displays the auxiliary region 212 in a full-screen mode, and the second display module 95 executes the selected game application and displays the major region 210 in the full-screen mode.

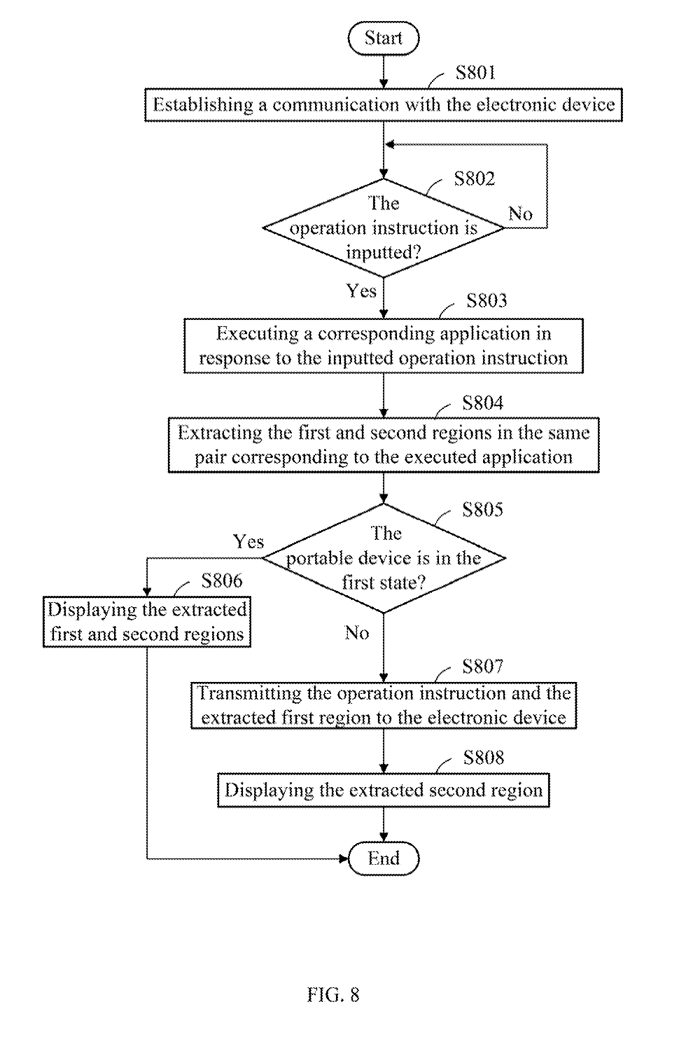

FIG. 8 shows a control method for a portable device 100 to control the electronic device 99 to execute a corresponding application and display parts of an interface of the executed application. The portable device 100 is capable of switching between a first state and a second state, and presets a plurality of interface 21 which corresponds to different applications. Each of the interfaces defines a major region 210 and an auxiliary region 212. In the embodiment, the portable device 100 is a tablet, and the electronic device 99 is a television; the major region 210 can display images, video, or text information, for example. The auxiliary region 212 can displays comments related to the displaying movie, a visual remote controller with visual a plurality of control icons for example. The control method includes the following steps.

In step S801, the first communications module 10 of the portable device 100 establishes a communication with the second communication module 91 of the electronic device 99. In the embodiment, the first communications module 10 establishes the communication with the second communication module 91 wirelessly. In other embodiments, the first communications module 10 establishes the communication with the second communication module 91 via wires.

In step S802, the input module 30 determines whether an operation instruction is inputted. If the input module 30 inputs the operation instruction, the procedure goes to S803. If there is no operation instruction is input by the input module 30, the procedure returns to S802. The operation instruction can be inputted in a touch input mode and a voice input mode.

In step S803, in response to the operation instruction the execution unit 41 executes an application corresponding to the input operation instruction. In the embodiment, the executed application can be a movie display application, a game application, and a chatting application, for example.

In step S804, the execution unit 41 invokes the interface 21 corresponding to the executed application from the interface module 20.

In step S805, the information transmission unit 42 determines whether the portable device 100 is in the first state. If the portable device 100 is in the first state, the information transmission unit 42 transmits the interface 21 to the first display module 50 and the procedure goes to S806. If the portable device 100 is in the second state, the procedure goes to S807. The portable device 100 switches between the first state and the second state via operations of users. In the embodiment, the operations are a click operation on different visual icons displayed on the first display module 50 or different pressed mechanism buttons of the portable device 100.

In step S806, the first display module 50 displays the invoked interface 21 on the portable device 100.

In step 807, the information transmission unit 42 transmits the input operation instruction and the major region 210 of the interface 21 to the electronic device 99 which executes the operation instruction and displays the major region 210 of the interface 21.

In step S808, the first display module 50 displays the auxiliary region 212 of the interface 21 in a full-screen mode.

In use, when the portable device 100 is in the second state, the major region 210 of the interface 21 corresponding to the executed application is displayed on the electronic device 99 in a full-screen mode. Therefore, both the sizes of the major and auxiliary regions of interface 21 corresponding to the executed application are enlarged.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A portable device capable of communicating with an electronic device, the portable device comprising:
a first communication module for establishing a communication with the electronic device;
an input module for generating different operation instructions to execute different applications based on operations of users;
an interface module for presetting a plurality of interfaces corresponding to different applications;
a control module for executing an application corresponding to the input instruction and invoking the interface corresponding to the executed application; and
a first display module;
wherein the control module further transmits the input operation instruction and parts of the interface to the electronic device via the first communication module for controlling the electronic device to execute the input operation instruction and display the parts of the interface, the first display module displays other parts of the interface.

2. The portable device of claim 1, wherein each of the interface comprises a major region and an auxiliary region; the control module further comprises an execution unit and an information transmission unit; the execution unit executes a corresponding application corresponding to the operation instruction inputted by the input module and invokes the interface corresponding to the executed application from the interface module; the information transmission unit transmits the operation instruction and the major region of the invoked interface to the electronic device via the first communication module.

3. The portable device of claim 1, wherein the input module is capable of switching between a touch input mode and a voice input mode.

4. The portable device of claim 3, wherein input module further comprises a voice capturing unit and a voice recognition unit; the voice capturing unit obtains voice information when the input module is in the voice input mode; the voice recognition unit presets a plurality of voice information corresponding to different operation instructions; the voice recognition unit determines whether the obtained voice information matches one of the voice information and generates a corresponding operation instruction when the obtained voice information matches one of the voice information.

5. The portable device of claim 3, wherein the input module further comprises a touch input unit; when the input module is in the touch input mode, the touch input unit detects operations to generate different operation instructions.

6. The portable device of claim 4, further comprising a switch module; wherein the switch module also switches the input module between the touch input mode and the voice input mode.

7. The portable device of claim 6, wherein the switch module switches the portable device between a first state and a second state based on operations of users.

8. The portable device of claim 6, wherein when the portable device is in the first state, the control module transmits the invoked interface to the first display module for displaying.

9. A control method for a portable device to control an electronic device to execute a corresponding application and display parts of an interface of the executed application; the electronic device comprising a plurality of interface corresponding to different applications, the control method comprising:
establishing a communication with the electronic device;
determining whether an operation instruction is inputted;
executing an application corresponding to the input operation instruction when the operation instruction is inputted;
invoking an interface corresponding to the executed application;
transmitting the operation instruction and parts of the invoked interface to the electronic device which executes the operation instruction and displays the parts of the invoked interface; and
displaying other parts of the invoked interface on the portable device.

10. The method of claim 9, wherein the electronic device is capable of switching between a first state and a second state; after the step of invoking an interface corresponding to the executed application further comprising:
determining whether the portable device is in the first state; and
displaying the invoked interface on the portable device when the portable device is in the first state.

11. The method of claim 9, wherein the input instruction is inputted in a touch input mode.

12. The method of claim 9, wherein the input instruction is inputted in a voice input mode.

13. The method of claim 9, wherein each of the interfaces comprises a major region and an auxiliary; when the portable device is in the second state, the major region of the invoked interface is transmitted to the electronic device and displayed in a full-screen mode.
